(19) United States
(12) Patent Application Publication
(10) Pub. No.: US 2002/0037239 A1
(43) Pub. Date: Mar. 28, 2002

(54) Quantitative suction tip and quantitative suction apparatus

(75) Inventor: Akihiro Komatsu, Kanagawa (JP)

Correspondence Address: SUGHRUE, MION, ZINN, MACPEAK & SEAS, PLLC, 2100 Pennsylvania Avenue, N.W., Washington, DC, 20037-3202, US

(73) Assignee: FUJI PHOTO FILM CO., LTD.

(21) Appl. No.: 09/960,341

(22) Filed: Sep. 24, 2001

(30) Foreign Application Priority Data
Sep. 22, 2000 (JP) 288245/2000

(51) Int. Cl. B01L 3/02

(52) U.S. Cl. 422/100

(57) ABSTRACT

A quantitative suction tip to be attached onto the tip of a suction nozzle 5 comprises a fixed volume chamber 12 with a predetermined volume. The fixed volume chamber 12 has a suction opening formed at a lower end thereof and a division wall 13 formed at an upper end thereof. The division wall 13 has a through hole 15 which has a smaller cross-sectional area than that of the fixed volume chamber 12. As a liquid fills the fixed volume chamber 12 and reaches the through hole 15, there is caused a change in the suction pressure which is detected to terminate a suction operation. Thus, a predetermined quantity of the liquid can be accurately drawn into the quantitative suction tip without being affected by e.g. the surface tension and viscosity of the drawn liquid or the wettability of the inner walls of the quantitative suction tip.

### BACKGROUND OF THE INVENTION

1. Field of the Invention

The present invention relates to a quantitative suction tip and a quantitative suction apparatus used for the drawing by suction of a predetermined quantity of liquids in an analysis apparatus and the like.

2. Description of the Prior Art

In a quantitative analysis, for example, a predetermined quantity of a liquid such as that of a sample is often drawn by suction and then discharged as a drop onto an analysis element and the like. During such measurement, it is important to accurately draw and supply a predetermined quantity of a given liquid if the measurement accuracy is to be improved.

In the prior art, such a quantitative suction of a liquid has been performed by using a suction pump such as a syringe. In this case, the spatial volume of the syringe is varied in proportion to a quantity of the liquid to be drawn, so that the resultant pressure can act on a suction nozzle to thereby draw the quantity of the liquid. Namely, a volume of air corresponding to the quantity of the liquid to be drawn is drawn so that the resultant negative pressure acts on the suction nozzle, thereby drawing just the quantity of the liquid corresponding to the drawn air.

When the liquid is directly drawn by the suction nozzle, it is necessary to clean the suction nozzle whenever the type of liquid is changed. However, this can lead to a contamination due to a residue of the previously used liquid, thereby lowering the measurement accuracy. In addition, as the cleaning operation reduces the availability of the system, the measurement performance of the system as a whole may be reduced. To overcome those problems, the prior art has utilized a tip which is attached on the suction nozzle. In this technique, the liquid is drawn into the tip and the tip is replaced whenever the liquid is changed.

### SUMMARY OF THE INVENTION

However, when such a tip is used during the suction of a liquid, it is difficult to accurately draw and retain a predetermined quantity of the liquid within the tip by the control of the negative pressure on the suction pump side. Namely, due to e.g. the surface tension and viscosity of the liquid and the wettability of the inside walls of the tip, there arises a force in the drawn liquid opposing the suction force. As a result, the quantity of the liquid that is actually drawn into the tip becomes less than the predetermined quantity even if the spatial volume of the suction pump is varied in proportion to the quantity of the liquid desired to be drawn, resulting in a reduced suction accuracy.

It is plausible to reduce the influence of the wettability by increasing the water repellency of the tip surfaces. However, there still remain other unknown values including the surface tension and viscosity of the drawn liquid that cannot be dealt with, thereby causing an error in the quantity drawn and lowering the accuracy in the measurement and/or analysis, for example.

Accordingly, it is an object of the present invention to provide a quantitative suction tip for allowing a predetermined quantity of a liquid to be accurately drawn without being influenced by e.g. the surface tension and viscosity of the drawn liquid and the wettability of the inside walls of the tip. It is another object of the invention to provide a quantitative suction apparatus using such tip.

To achieve the above-mentioned objectives, the invention provides a quantitative suction tip to be attached onto the tip of a suction nozzle for the suction of a liquid. The quantitative suction tip comprises a fixed volume chamber of a predetermined volume with a suction opening provided at a lower end thereof, and a through hole provided in a division wall at an upper end of the fixed volume chamber. The through hole has a smaller cross-sectional area than that of the fixed volume chamber.

The fixed volume chamber may be provided with a fitting portion thereon for fitting a periphery of the tip of the suction nozzle. The fixed volume chamber and the fitting portion may be separately formed and then combined into a single structure by engagement. Further, an engaging portion may be provided over the through hole in the fixed volume chamber for engagement with the tip portion of the suction nozzle.

The invention also provides a quantitative suction apparatus that employs the aforementioned quantitative suction tip. The quantitative suction apparatus comprises a suction pump for drawing a liquid into the fixed volume chamber by causing a suction pressure to exist within the fixed volume chamber of the quantitative suction tip. The apparatus further comprises a control unit which detects the suction pressure and stops a drawing operation by the suction pump upon detection of a change in the suction pressure indicating that the liquid has filled the fixed volume chamber and reached the through hole.

The difference in cross-sectional area between the through hole formed in the division wall and the fixed volume chamber is set such that a sufficient pressure change can be obtained for the sensitivity of the pressure detection unit for detecting the pressure change indicating the arrival of the drawn liquid at the through hole.

By thus employing the quantitative suction tip comprising the fixed volume chamber of a predetermined volume and the through hole with a different cross-sectional area than that of the fixed volume chamber, the drawing can be stopped on the basis of a pressure change indicating that the liquid has reached the though hole. Thus, a volume of the liquid filling the fixed volume chamber can be accurately quantitatively drawn, thereby ensuring a satisfactory suction accuracy. Accordingly, a predetermined quantity of the liquid can be drawn without being affected by e.g. the surface tension and viscosity of the liquid to be drawn and the wettability of the inside walls of the tip. Further, when the quantity drawn is to be changed, simply the volume of the fixed volume chamber may be changed without changing the suction quantity by the suction pump, so that better control can be obtained.

### BRIEF DESCRIPTION OF THE DRAWINGS

Hereunder preferred embodiments of the present invention will be described by referring to the drawings, in which:

FIG. 1 shows a cross section of a quantitative suction tip attached to the tip of a suction nozzle in accordance with an embodiment of the invention;

FIG. 2 shows a graph plotting an example of a pressure variation in response to suction;

FIG. 3 schematically shows the mechanism of a quantitative suction apparatus;

FIGS. 4 shows a cross section of a quantitative suction tip in accordance with another embodiment; and

FIG. 5 shows a cross section of a quantitative suction tip, together with a suction nozzle, in accordance with yet another embodiment of the invention.

### DESCRIPTION OF THE PREFERRED EMBODIMENTS

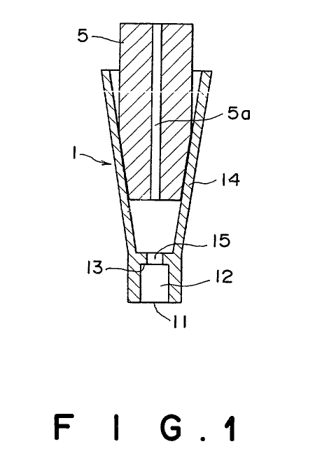

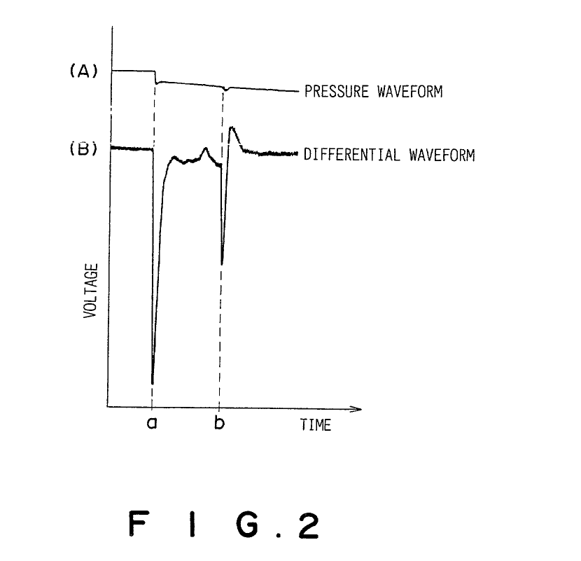

FIG. 1 is a cross-sectional view of an exemplary quantitative suction tip attached to the tip of a suction nozzle according to an embodiment of the invention. FIG. 2 is a graph plotting an example of pressure variation as a result of suction.

A quantitative suction tip 1 according to the present embodiment is similar to a pipet in overall shape. The quantitative suction tip 1 therefore has a suction opening 11 at the bottom into which a liquid flows. The suction opening 11 connects to a fixed volume chamber 12 with a predetermined volume. At the top of the fixed volume chamber 12 is provided a division wall 13. The division wall 13 is integrally formed with a fitting portion 14 provided thereon opposing a suction nozzle 5. The fitting portion 14 is conically shaped with a gradually increasing internal diameter, such that it can accommodate the tapered surface of the periphery of the tip of the suction nozzle 5 from above in a closely fitting manner. Thus the quantitative suction tip 1 can be attached to the suction nozzle 5 by the fitting force.

A through hole 15 is formed in the division wall 13 of the fixed volume chamber 12. The through hole 15 has a cross-sectional area (opening area) which is smaller than that of the fixed volume chamber 12 (i.e., the opening area of the suction opening 11 in the illustrated example), such that the cross-sectional area varies in a step at the bottom opening portion of the through hole 15. The suction nozzle 5 has an air passage 5a formed therethrough along its central axis for introducing a suction pressure into the fixed volume chamber 12 via the through hole 15.

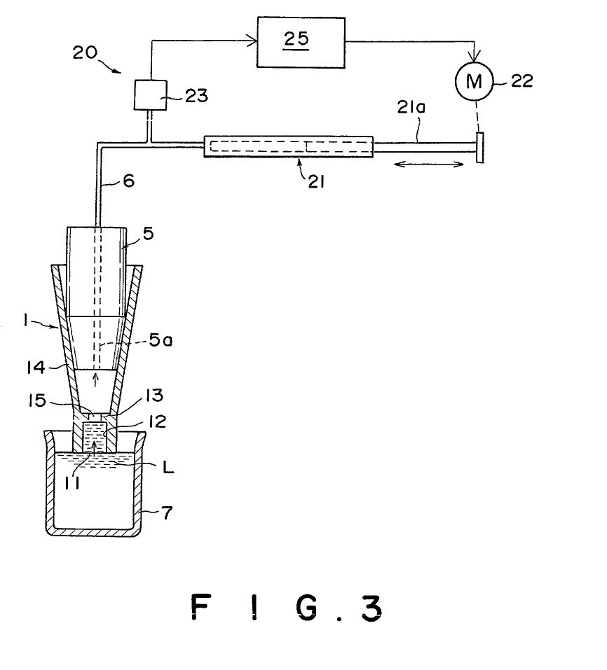

In the quantitative suction tip 1, a liquid L (see FIG. 3) is drawn by suction through the suction opening 11 and fills the fixed volume chamber 12. As the liquid L reaches the through hole 15, the suction pressure varies because of the change in sectional area at the through hole 15. Upon detecting this change in suction pressure, the suction operation is stopped, whereby a volume of the liquid L corresponding to the volume of the fixed volume chamber 12 can be accurately drawn into the fixed volume chamber 12.

FIG. 2 shows a voltage variation of a detection signal in response to pressure changes when the liquid L is drawn by the introduction of a negative pressure into the quantitative suction tip 1. In FIG. 2, waveform (A) is a detected waveform and waveform (B) is a differential waveform obtained by converting the variation of the detected waveform.

As the suction nozzle 5 with the quantitative suction tip 1 attached thereon is lowered, the suction opening 11 contacts the surface of the liquid L at point a, at which point suction is commenced. At point a, the suction opening 11 is closed by the liquid L, so that the resistance to suction is increased by the drawing of the liquid L as compared with the previous state where air was being drawn. Thus the pressure of (A) decreases (i.e. the suction negative pressure increases), and the differential waveform (B) greatly fluctuates to the negative direction correspondingly. As point a is passed, suction of the liquid L into the fixed volume chamber 12 continues with a substantially stable pressure.

At point b where the drawn liquid L has filled the fixed volume chamber 12, the level of the liquid L reaches the through hole 15 of the division wall 13. As the cross-sectional area of the through hole 15 is smaller at point b, the pressure (A) further decreases (the suction negative pressure increases), and accordingly the differential waveform (B) fluctuates in the negative direction. The pressure change at point b can be detected by e.g. determining the magnitude (voltage) of the variation of the differential waveform (B), and the suction operation can be stopped at this point. Thus, by terminating the suction of the liquid L when the fixed volume chamber 12 has been filled, a quantitative suction of the liquid L can be effected. FIG. 2 also shows the pressure variation as the suction was continued after passing point b.

The difference in sectional-area between the through hole 15 and the fixed volume chamber 12 is set such that a sufficient pressure change can be obtained for a given detection sensitivity. By setting a threshold corresponding to the magnitude of the pressure change (differential waveform), the pressure change at the through hole 15 can be discriminated from minute pressure fluctuations during suction up to the time when the fixed volume chamber 12 is filled with the liquid L, thereby ensuring a reliable detection.

Thus, by using the quantitative suction tip 1 having the fixed volume chamber 12 and the through hole 15, a predetermined quantity of the liquid L corresponding to the volume of the fixed volume chamber 12 can be accurately drawn on the basis of the change in suction pressure. Further, by preparing another quantitative suction tip 1 with a fixed volume chamber 12 of a different volume, a different volume of the liquid L can be quantitatively drawn.

FIG. 3 shows a schematic illustration of the mechanism of a quantitative suction apparatus 20 using the quantitative suction tip 1. The quantitative suction apparatus 20 is equipped with a suction nozzle 5 on which the quantitative suction tip 1 is attached. The nozzle 5 has an air passage 5a opening at the tip thereof. The air passage 5a is connected with an air circuit 6 from a suction pump 21. The suction pump 21 is formed by e.g. a syringe pump capable of generating small negative pressures with little ripples, and is actuated by a motor 22. In the illustrated suction pump 21 using a syringe pump, negative and positive pressures are generated by moving an internal piston member 21a depending on a positive or negative rotation of the motor 22. The generated pressure is introduced by the air circuit 6 into the fixed volume chamber 12 through the air passage 5a inside the suction nozzle 5 and the through hole 15 of the quantitative suction tip 1.

The air circuit 6 is connected to a pressure sensor 23 for detecting the suction pressure. The pressure sensor 23 outputs a detection signal which is sent to a control unit 25. Based on a variation of the detected pressure, the control unit 25 determines the point in time (point b) when the fixed volume chamber 12 of the quantitative suction tip 1 has been filled by the liquid L, at which point it outputs a stop signal to the motor 22 to terminate the suction operation by the suction pump 21.

Hereunder the process of suction by the quantitative suction apparatus 20 will be described. First, the quantitative suction tip 1 is transported from an initial position to an area above a vessel 7 containing the liquid L in preparation for the suction of the liquid L into the quantitative suction tip 1. The suction nozzle 5 is then lowered until the tip of the quantitative suction tip 1 is dipped in the liquid L by a predetermined depth. The suction nozzle 5 then starts drawing the liquid L, and the drawing operation is continued until the fixed volume chamber 12 is filled with the liquid L. As the liquid L reaches the through hole 15, the aforementioned pressure change is detected, and the suction operation is terminated. Thereafter the quantitative suction tip 1 is lifted together with the suction nozzle 5.

The amount by which the tip of the quantitative suction tip 1 is dipped into the liquid is controlled depending on the viscosity of the liquid L and the like, such that the suction of the liquid L will not be interrupted and that the liquid L will not attach to the periphery of the suction opening 11 when the quantitative suction tip 1 is lifted.

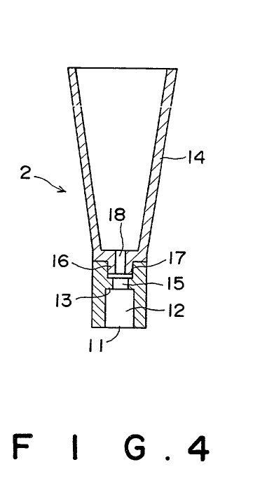

FIG. 4 shows a cross-sectional view of a quantitative suction tip 2 in accordance with another embodiment of the invention. In this embodiment, the fixed volume chamber 12 is made replaceable to accommodate changes in the quantity of the liquid to be drawn.

The quantitative suction tip 2 in the present embodiment comprises a fixed volume chamber 12 and a separately formed mating portion 14. The fixed volume chamber 12 has a suction opening at the tip thereof and a division wall 13 at the upper end thereof. The division wall 13 has a through hole 15 with a smaller cross-sectional area than that of the fixed volume chamber 12. The division wall 13 also has an engaging concave portion 17 formed thereon which is adapted to closely engage an engaging convex portion 16 formed at the tip of the fitting portion 14. The engaging convex portion 16 of the fitting portion 14 has an air hole 18 adapted to be in communication with the through hole 15 of the division wall 13. The concave-convex relationship between the fixed volume chamber 12 and the fitting portion 14 may alternatively be reversed from the illustrated example, i.e., the fixed volume chamber 12 may have an engaging convex portion and the fitting portion 14 an engaging concave portion.

In the present embodiment, the fitting portion 14 to be fitted on the suction nozzle 5 does not contact the liquid L, and when the suction quantity and/or the liquid L is to be varied, only the fixed volume chamber 12 can be either replaced or discarded.

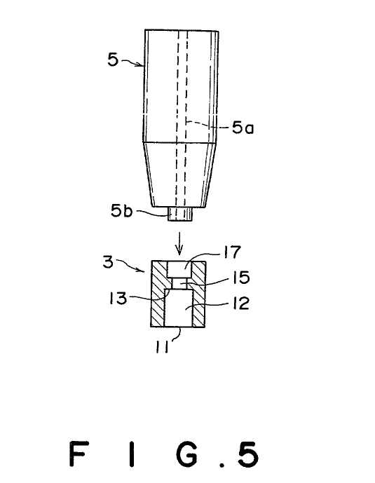

FIG. 5 shows a cross-sectional view of a quantitative suction tip 3 in accordance with yet another embodiment of the invention. In this embodiment, the quantitative suction tip 3 is substantially formed only by the fixed volume chamber 12, and the suction nozzle 5 differs from the ones according to the previously described embodiments.

In the present embodiment, the quantitative suction tip 3 has the fixed volume chamber 12 with a suction opening 11 formed at the tip thereof. At the upper end of the fixed volume chamber 12 is formed a division wall 13. The division wall 13 has a through hole 15 with a smaller cross-sectional area than that of the fixed volume chamber 12. The division wall 13 also has an engaging concave portion 17 formed thereon. On the other hand, an engaging convex portion 5b is formed at the tip of the suction nozzle 5 to closely engage the engaging concave portion 17. The suction nozzle 5 has an air passage 5a which opens at the tip of the engaging convex portion 5b and is adapted to be in communication with the through hole 15.

In the present embodiment, since the quantitative suction tip 3 is smaller, further cost reduction can be achieved and there will be less space required in the system for storing the tip.

What is claimed is:

1. A quantitative suction tip to be attached on a tip of a suction nozzle for the suction of a liquid, comprising:
a fixed volume chamber with a predetermined volume and having a suction opening provided at a lower end thereof; and
a through hole provided in a division wall formed at an upper end of said fixed volume chamber, said through hole having a smaller cross-sectional area than that of said fixed volume chamber.

2. A quantitative suction tip according to claim 1, wherein a fitting portion is formed on said fixed volume chamber for fitting with a periphery of the tip of said suction nozzle.

3. A quantitative suction tip according to claim 2, wherein said fixed volume chamber and said fitting portion are separately formed and then engagingly combined to form a unit.

4. A quantitative suction tip according to claim 1, wherein an engaging portion is formed over said through hole of said fixed volume chamber to engage the tip of said suction nozzle.

5. A quantitative suction apparatus using the quantitative suction tip according to claim 1, comprising:
a suction pump for drawing a liquid into said fixed volume chamber by causing a suction pressure to exist in said fixed volume chamber of said quantitative suction tip; and
a control unit for detecting the suction pressure and terminating a suction operation by said suction pump upon detection of a change in the suction pressure indicating that the liquid has filled said fixed volume chamber and therefore has reached said through hole.
